(19) United States
(12) Patent Application Publication
(10) Pub. No.: US 2009/0141190 A1
(43) Pub. Date: Jun. 4, 2009

(54) Rear projection immersive display system

(76) Inventor: William Steven Kroll, Houston, TX (US)

Correspondence Address: William Steven Kroll, 5118 Contour Pl., Houston, TX, 77096, US

(21) Appl. No.: 11/999,335

(22) Filed: Dec. 4, 2007

(51) Int. Cl. H04N 9/31; G06F 3/041; H04R 5/02

(52) U.S. Cl. 348/744; 345/173; 381/307; 348/E09.025

(57) ABSTRACT

An immersive rear projection imaging and audio system with interactive capability. It utilizies a single projection device. Said device receiving its image correction information via a computer interface. The computer interface is performing 3-D geometric image reformation and correction from the source. Said source may be supplied by any commercially available media or means. The receiving surface of the specially treated, vertically oriented open ended dome screen having a truncated lower quadrant section. Within said hemispherical display screen, the viewer's field of vision is immersed within the projected image. We further cause an immersive audio experience within this same space and present a method for producing same.

### BACKGROUND OF THE INVENTION

Hemispherical optical projection systems are used to project images onto the inner surfaces of domes. Such systems are used in planetariums, flight simulators, and in various hemispherical theaters. With the present interest in virtual reality and three-dimensional rendering of images, hemispherical optical projection systems are being investigated for projecting images which simulate a real and immersive environment.

Typically, hemispherical dome-shaped optical projection systems include relatively large domes having diameters from about 4 meters to more than 30 meters. Such systems are well suited for displays to large audiences. However, such systems may be large and cumbersome and often cost several hundreds of thousands of dollars, thus making them prohibitively expensive for many uses.

Said, previously referenced systems typically utilize front projection techniques. The front projection method is not well suited to single-user and other small-scale systems because they typically locate the projection apparatus, or a part thereof, in the same ideal area in which we desire to place the viewer. That drawback is overcome through the use of rear-projection techniques as described herein.

Previous immersive viewing domes have not utilized the dome as a lens in rear projection mode which takes advantage of the transparent dome acting as a lens. We have further enhanced this element by applying a diffuser onto the exterior of the dome. The method of application of this diffusion element is described herein.

### FIELD OF THE INVENTION

The present invention relates to visual projection systems and, more particularly, to visual projection systems including projection dome theatres designed to single-user human-scale that are less than 3 meters in diameter

### SUMMARY OF THE INVENTION

Embodiments of the immersive rear-projection display system according to the present invention are adapted for use by a viewer and include a dome, having a vertically oriented open front end with a light shaping diffuser on its convex exterior surface and a touch screen display situated within said dome structure oriented within same in a manner which does not interfere with the dome's projection surface.

According to other embodiments of the present invention, an immersive rear-projection display system according to the present invention are adapted for use by a viewer and include a dome, having a vertically oriented open front end with a light shaping diffuser on its exterior (convex) surface and a touch screen display situated within said dome space structure visual presentation system for use by a viewer includes a dome having an open front end and a truncated lower quadrant section allowing the viewer to physically enter the dome structure.

According to other embodiments of the present invention, an immersive rear-projection display system according to the present invention are adapted for use by a viewer and include a dome, having a vertically oriented open front end with a light shaping diffuser on its exterior (convex) surface and a touch screen display situated within said dome space structure visual presentation system for use by a viewer includes a dome having an open front end and a truncated lower quadrant section allowing the viewer to physically enter the dome structure. A projector is located outside the dome to project a geometrically corrected concave projection onto the convex outer dome surface.

According to other embodiments of the present invention an immersive rear-projection display system according to the present invention are adapted for use by a viewer and include a dome. Said dome having a vertically oriented open front end with a light shaping diffuser on its exterior (convex) surface and a touch screen display situated within said dome space structure visual presentation system for use by a viewer includes a dome having an open front end and a truncated lower quadrant section thus allowing the viewer to physically enter the dome structure for an effective immersive viewing experience. A projector is located outside the dome to project a geometrically corrected concave image onto the convex outer dome surface. An interactive touch screen display is provided to the viewer to control the environment, including but not limited to, interaction with the projection dome image, the interior secondary display and the audio system.

The transparent dome acts as a lens, its geometry effectively bending the incoming light of the projection system inwards towards the viewer. A plurality of randomized micro-articulated structures on its convex outer surface render it as an effective light shaping diffuser. These randomized micro-articulated surface features on the convex exterior of the dome provide an effective means of capturing the projector's image from a wide possible range of angles and efficiently transferring them onto the primary interior (concave) viewing surface of the dome.

Objects of the present invention will be appreciated by those of ordinary skill in the art from a reading of the Figures and the detailed description of the preferred embodiments which follow, such description being merely illustrative of the present invention.

### A BRIEF DESCRIPTION OF THE DRAWINGS

FIG. 1: Provides an isometric view of the major components of the system.

1.) The outer surface of the truncated dome receiving the projected imagery

2.) A molded flange section of the dome provided additional structural integrity and blocking some possible over-projection

3.) The primary viewing (interior) surface of the dome

4.) The structure which supports the dome. Its design may be of various and/or variable height.

Its primary role is to maintain the dome in proper orientation. It also acts as support for the touch input display, PC system, possible gaming console and associated apparatus as well as the audio system.

5.) Speakers of the audio system may be of various number size and orientation.

They may be flush mounted with the interior surface of the support structure or surface mounted for varying requirements.

6.) Touch screen display. This may have an integrated PC system for communication to the projector

7.) Support structure floor surface. This may be include a seating surface for the viewer when or if desired.

8.) The projection device.

FIG. 2: Is a side view of the system showing various possible configurations

1.) The viewer at the initial point of visual immersion

2.) The truncated dome with mounting support structure

3.) The projection device at a close-coupled distance and above the truncated dome screen

4.) The projection device at a close-coupled distance and in-line with the viewer's line of sight

5.) The projection device at long distance and above the truncated dome screen

6.) The projection device at a long distance and in-line with the viewer's line of sight

FIG. 3A: A top cross section view of the projection device and the truncated dome

1.) Data transmission cable

2.) Wireless data transmitting and receiving device

3.) Projector body

4.) Lens assembly

5.) Path of the image projection cone

6.) The truncated dome

7.) The point of viewer reference

FIG. 3B: An isometric cross section view of the dome surface

1.) The outer (convex) surface of the truncated dome. Its surface having a random micro-articulated texture.

2.) The inner (convex) surface of the truncated dome. Its surface having a relatively smooth (polished) texture.

### DETAILED DESCRIPTION OF THE INVENTION

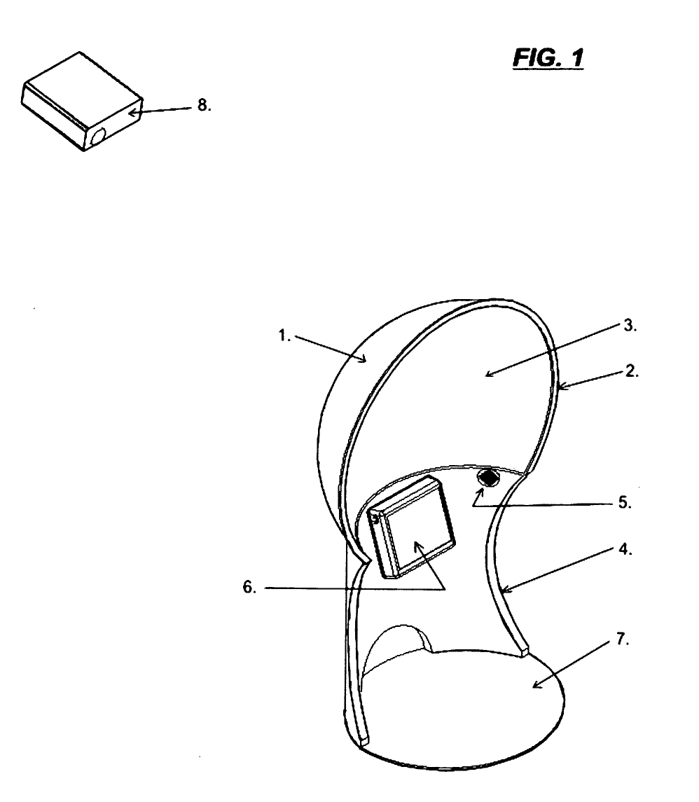

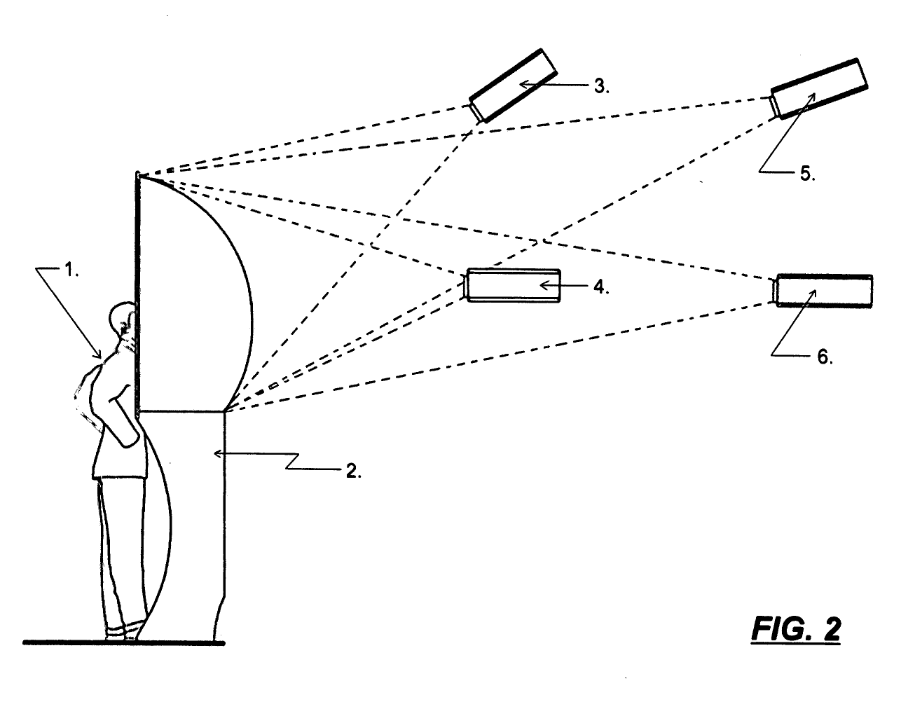

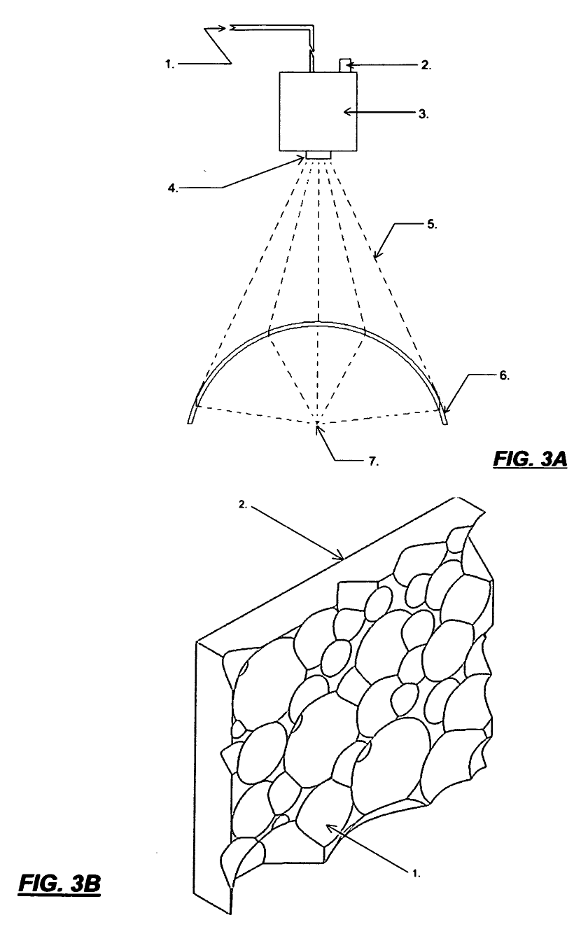

Referring to FIG. 1, a preferred embodiment of the rear projection immersive display system described herein, indicated generally at reference numeral 1 is the truncated dome. Said truncated dome being primarily spherical in geometry. It is formed from a material having a high index of refraction.

Said high index of refraction being above the refractive index of the air which surrounds it. Said material may be, though not limited to, polymethyl methacrylate, commonly referenced by the trade name of acrylic, polyacrylate, or of a glass of any known nature. The high index of refraction being desirable in this application as it enhances the viewability of the image formed on the surface of the truncated dome screen.

In the embodiment illustrated, said dome shaped screen has its front edge finished with a flange (2), the dimension of which may be of a width relative to the thickness of the material being utilized, this being especially desirable when the dome is formed from polymers as this enhances the structural integrity. Its primary viewing surface is the interior (concave) surface as indicated by the numeral 3. Said truncated dome having a supporting structure as indicated by the numeral 4. The dimensions and design may vary from that illustrated to enhance the viewer experience and is dependent on the particulars of the application for the rear projection immersive display system.

The supporting structure may also incorporate an audio system as indicated by numeral 5. Said audio system being composed of speaker elements and other pertinent audio components. Their position within the structure being determined by the audio characteristics of the elements themselves and the desired audio experience. The system may be interactive or passive in nature.

The interactivity of the viewer may be enhanced by the touch screen display interface as shown by numeral 6, or another device. Installation of the support structure and truncated dome is enhanced by incorporating a floor structure as illustrated and referenced to by the numeral 7.

The singular projection device (8) being aimed at the outer convex surface of the truncated dome screen.

Referring to FIG. 2, We note that the truncated section of the dome screen allows the viewer, indicated by numeral 1., to step within the imaging device (2). This ability to immerse the viewer's vision is an essential element for a robust experience.

The relationship between the imaging device and the projection system is variable in distance and angularity. While not limited to the variable positions shown in numerals 3, 4, 5 and 6. Said positions are to be considered as examples of the flexibility of the system installation.

The installed position as indicated by numeral 3 is a commercially desirable for ceiling installations where there is also a limited distance between the projector and the dome available. Numeral 4 illustrates a position wherein the image is maximized due to its close coupling to the display screen. In some instances it is found desirable to locate

Referring to FIG. 3A wherein we indicate various components which comprise the system. Numeral 1, is a data communications cable which may be desirable in communicating video images and or information between the projection device (3) and an external PC computer and its associated lens system as indicated by numeral 4.

The projection device may be any commercially available digital projector which has the ability to communicate its image input information in a digital, rather than a wholly analogue, manner. It may also be a projection device which has, incorporated as a unitary system, the computational and data storage necessary for three-dimensional geometric reformation of the output image.

Shown by the item indicated by the numeral 2 is a wireless transceiver, said wireless device being used as an alternate to the data communications cable or working in concert with same. These communications devices are essential in the case wherein the projection device does not have the self-contained computational ability and/or storage capacity to perform geometric reformation.

Geometric reformation is a software based system whereby the standard two dimensional image information is warped to optimize and or correct its appearance on three dimensional surfaces rather than a (conventional) two dimensional flat plane.

In our system, the image projection cone, as indicated by numeral 5 has been geometrically reformed to the spherical geometry of the truncated dome (6). Said image is transferred through the high refraction material of the dome towards the viewer as represented by point indicated by numeral 7.

Referring to FIG. 3B the material comprising the truncated dome is seen as a cross section. The outer-convex surface, as shown by numeral 1 has been subjected to controlled abrasion techniques. The method for creating this surface is commercially described and referred to as media blasting, sand blasting and bead blasting.

The method of media blasting, in our preferred embodiment, utilizes commercially available Aluminum Oxide abrasive media. Applying this abrasive media to the outer surface as described, creates a topology of a randomized nature. The texture is comprised of microscopic crater-like and often overlapping features that act as small lenses.

Said aforementioned small lenses are often referred to as lenslets. These lenslets increase the effective surface area of the dome's outer surface thus also increasing the surface's ability to collect light. This is especially important as the curved surface of the dome creates a situation in which we must collect the image information at narrow angles of incidence. The concave geometry of the lenslets also assists in bending the incoming light from the projection source. This property is further enhances by said bent light being further redirected towards the viewer because of the high refraction index of the dome's substrate material.

The randomized, rather than regular, placement on the surface effectively creates another valuable property inherent in our method of creating the surface topology. Said randomized surface characteristics effectively create what is referred to as an optical light diffuser.

This is a desirable optical property of the surface structure as this distributes the projection light evenly and minimizes hot-spotting. This diffusion optics property allows our placement of the projector within line sight of the viewer. Said placement in line-sight may be done without the viewer being able to discern the origin of the image.

The interior of the dome projection material (2) is substantially smooth in texture. It may be enhanced through the application of anti-glare treatments. Further optical enhancement to the image contrast of the dome screen display may be provided by utilizing material which is tinted.

We claim:

1. An economical method for the production of an immersive and interactive rear projection theatre and information delivery system. The system may, but is not limited to, the use of a single projection source, rather than a plurality, to provide an immersive viewer experience.

2. The method of claim 1 further comprising the step of: pre-warping subsequent displayed input video signals using the warping map is utilized in a rear projection method utilizing an open ended vertically oriented dome that the viewer may enter the display system as an immersive environment.

3. The method of claim 2 wherein the vertically oriented rear projection dome which has the lower quadrant truncated. The resulting geometry allows the viewer to enter the interior of said dome. Entry by the user and or viewer in this embodiment being the viewer's total normal and peripheral field of view. The total ideal field of view being 180 degrees of horizontal field of view, in the, thus allowing a true 180 degree horizontal field of image presented view, a ninety degree view upward and varying degrees (dependent on the viewer's perspective) downward. Said downward field of view is also adjustable via possible seating positions, platforms and variable dome support options.

4. A duality of display systems is utilized wherein there is a display which is immersive (a.k.a., the dome) as well as a display of this same image which is easily accessible to the viewer from within the immersive open-ended dome environment. The interior display comprised of an LCD or similar display system which has a touch screen interface.

5. The interior touch display as described in claim 4. Is replaced with a game console and any form of controls said game console may require

6. The geometry of the dome display is also an immersive audio environment, said environment having the advantage of encompassing the listener with sufficient volume levels which are effectively contained within the display dome, thereby not severely disturbing the immediate surrounding environment.

7. The immersive audio environment as described in claim 6. Is accomplished with an optimized arrangement of audio outputs. Said arrangement being comprised of a plurality of audio devices which may be arranged according to the required task at hand. Said orientations being described as one or both in terms of spatial and geometric in nature

8. The open-ended dome projection imaging system of claim 1, is provided in an economical method. We have discovered that a randomized micro-sized surface relief pattern, previously created through holographic replication techniques, is at least as effective when produced by the application of 120 grit (or smaller) commercially available abrasive blasting techniques onto a substrate of substantially optically transparent substrate. Our experiments have shown that we achieve a greater than eighty percent optical transmission efficiency wherein the substrate is an optically clear acrylic and the media applied is an Aluminum Oxide (commercially available) via standard blasting equipment. Maintaining the blasting cone source at ninety degrees in relation to the dome's outer surface has proven to improve light transmission quality.

9. Controlled Abrasion of the surface of the acrylic dome in the manner as described in claim 6 effectively produces a light shaping diffuser. This light-shaping provides for an evenness of light distribution within the viewing area of the dome, effectively capturing the image from the projector and bending it towards the viewer thereby enhancing the throughput of the projection light

10. The light shaping diffuser effect of claim 7 reduces the undesirable effect commonly known as hot-spotting, This phenomenon is common to rear-projection systems and many previous inventions have been produced to reduce this condition. Our simple and economical abrasive technique allows the projector to be placed in line sight of the viewer without undesirable effects.

11. Further desirable characteristics of claim 8 allow the projection device to be placed in a wide range of positions relative to the projection dome surface. A wide range of projection device mounting positions, relative to the immersive dome projection surface is a desirable characteristic as this allows installation flexibility

12. The surface of the acrylic surface may be further enhanced with commercially available nano-sealants. This type of sealant system protects the abraded and microscopically fractured surface of the acrylic without, prohibitively, degrading the light diffusing characteristics of the abraded surface. Said sealant system allows for cleaning of the surface and provides enhanced surface hardening, reduced surface energy, UV resistance as well as enhanced ability to repel oils, water and other undesirable contaminates
